(19) United States
(12) Patent Application Publication
(10) Pub. No.: US 2003/0061378 A1
(43) Pub. Date: Mar. 27, 2003

(54) Automatic request forwarding method and system

(76) Inventor: John Joseph Mazzitelli, Sicklerville, NJ (US)

Correspondence Address: HEWLETT-PACKARD COMPANY, Intellectual Property Administration, P.O. Box 272400, Fort Collins, CO, 80527-2400, US

(21) Appl. No.: 09/964,035

(22) Filed: Sep. 26, 2001

(51) Int. Cl. G06F 15/173

(52) U.S. Cl. 709/238

(57) ABSTRACT

The present invention comprises a method for automatically forwarding a request. The method comprises receiving a request from a client enabled to communicate using an Internet communications protocol. The request comprises at least a first portion. The method also comprises transforming the request if the request is associated with a desired URL address that comprises the at least a first portion and another portion. The method also comprises automatically forwarding the request to the desired URL address.

### TECHNICAL FIELD OF THE INVENTION

The present invention relates in general to telecommunications and, more particularly, to an automatic request forwarding method and system.

### BACKGROUND OF THE INVENTION

Communication between points in a network such as the Internet requires specification of a destination address in the network in a request from a sender. Most communications over the Internet typically include the use of a protocol such as the HyperText Transfer Protocol (HTTP). A requestor may submit a request using HTTP for, as an example, a web page, to an address by specifying a Uniform Resource Locator (URL). In this way, a remote client such a browser operable to display information such as HyperText Markup Language (HTML) pages (such as Netscape® 6.01 or Microsoft's Internet Explorer) may submit a request for a web page to the specified URL.

In some cases, it may be desirable to provide the capability to automatically forward a specified URL to another URL. For example, some URLs may be easily misspelled, and sites may wish to increase traffic by improving the ease of access to their site by providing an alias or shortcut, to the real URL. As another example, many sites may provide a single destination through a series of URL paths. As another example, a company may choose to change the URL of its website, but not inconvenience those users who already have an existing URL bookmarked or otherwise saved. In this case, a web server may automatically forward a specified URL to another URL by informing the client to resubmit its request to the new URL.

Traditional methods for redirecting requests include commands that direct a remote client such a browser to redirect itself to a desired URL. Another method, as part of the HTTP protocol, provides for the web server to redirect the browser to a desired URL. Unfortunately, such a method typically suffers from disadvantages. In each of these cases, the browser is required to make two requests and thus two network connections. Furthermore, the client's second HTTP request requires additional network bandwidth. Depending on any network latency between clients and servers, this method may cause noticeable delays to the client in receiving a response from the intended URL. Moreover, such a method also requires that the client can translate the redirection command received from the server. Unfortunately, in some cases some clients may not have this capability.

### SUMMARY OF THE INVENTION

From the foregoing, it may be appreciated that a need has arisen for providing an efficient method for clients to perform online requests. In accordance with the present invention, an automatic request forwarding system and method are provided that substantially eliminate or reduce disadvantages and problems of conventional systems.

An automatic request forwarding method is disclosed. The method comprises receiving a request from a client enabled to communicate using an Internet communications protocol. The request comprises at least a first portion. The method also comprises transforming the request if the request is associated with a desired URL address that comprises the at least a first portion and another portion. The method also comprises automatically forwarding the request to the desired URL address.

Another embodiment of the present invention comprises a system for automatically forwarding a request. The system comprises a server in a network. The server is operable to receive a request from a client enabled to communicate using an Internet communications protocol over the network. The request comprises at least a first portion. The system also comprises an automatic forwarding application resident on the server. The application is operable to transform the request if the request is associated with a desired URL address that comprises the at least a first portion and another portion. The application is also operable to automatically forward the request to the desired URL address.

The present invention also encompasses an automatic request forwarding application. The application comprises a computer-readable storage medium, and application software resident on the computer-readable storage medium. The application software is operable to receive a request from a client enabled to communicate using an Internet communications protocol. The request comprises at least a first portion. The application software is also operable to transform the request if the request is associated with a desired URL address that comprises the at least a first portion and another portion. The application software is also operable to automatically forward the request to the desired URL address.

### BRIEF DESCRIPTION OF THE DRAWINGS

For a more complete understanding of the present invention and the advantages thereof, reference is now made to the following description taken in conjunction with the accompanying drawings, wherein like reference numerals represent like parts, and in which:

FIG. 1 is an example of a block diagram of a system that may be used for automatically forwarding a request according to an embodiment of the present invention;

FIG. 2 graphically illustrates a representation of an example of a mask that may be utilized according to an embodiment of the present invention; and

FIG. 3 illustrates an example of a method for automatically forwarding a request according to an embodiment of the present invention.

### DETAILED DESCRIPTION OF THE DRAWINGS

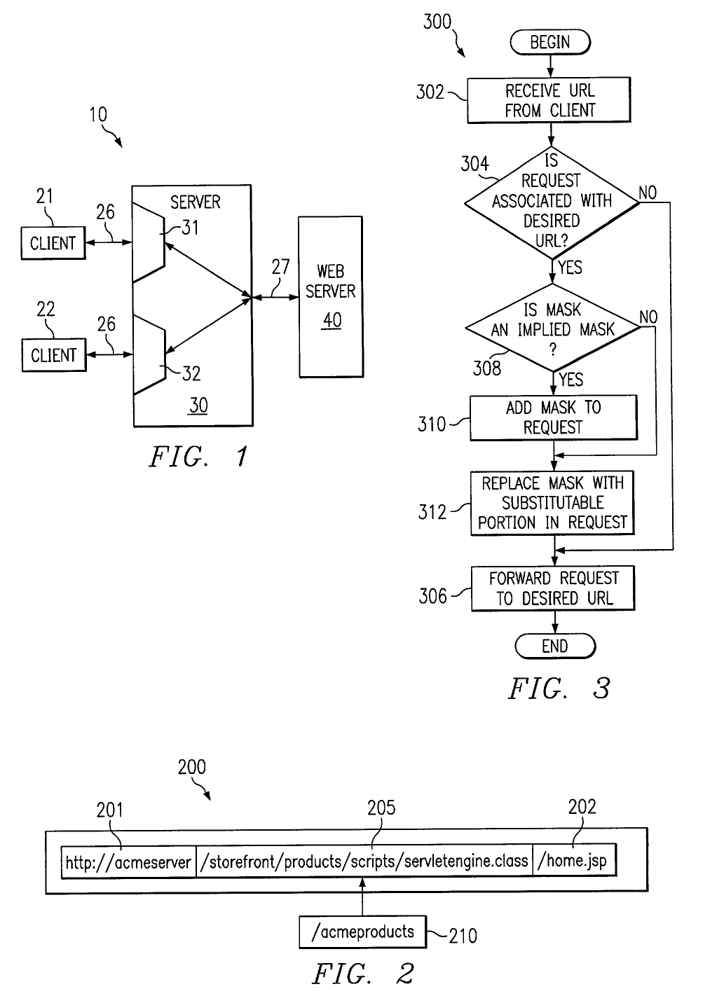

FIG. 1 is an embodiment of a block diagram of an request forwarding system 10. In the embodiment illustrated in FIG. 1, system 10 includes a server 30 that may be used to execute applications managed by one or more message applications 31 and/or 32. One technical advantage of the invention is that the invention may provide a method for automatically forwarding a request. Such an advantage removes the burden from the client of resubmitting its request, the method typically required with conventional systems. Moreover, such an advantage may reduce the delay otherwise experienced with the use of traditional methods in receiving a response from the server, and accordingly require less network bandwidth than traditional method. Moreover, such an advantage does not require the client to maintain the technology to translate redirection commands received from the server that are required with the use of traditional methods.

System 10 may be coupled to one or more remote clients 21 and/or 22 that are each enabled to communicate using an Internet communications protocol such as, but not limited to, HTTP and wireless application protocol (WAP), by any type of communication link 26, whether wireless or otherwise, from which it receives an URL request. Server 30 is operable to automatically forward the URL request to an intended web or universal business server 40 that is coupled to server 30 by any type of communication link 27, whether wireless, or otherwise. Server 30 may also in a particular embodiment control the overall function and operation of system 10. As illustrated in FIG. 1, server 30 may be a task-specific or custom-designed processing system that may be specifically configured to interface with various devices and to perform in accordance with the methods described herein. For example, in a particular embodiment, one or more applications 31 and/or 32 may reside in a Universal Session Manager product that may be implemented as a customized listener as part of a Universal Listener Framework (ULF) that is available from Hewlett-Packard Company. The ULF is an application framework, or set of related JAVA classes that may be used together for a particular application, and which may be used to handle requests from a variety of protocols. In the present invention, one or both of applications 31 and 32 may be used to automatically forward a request requested by client 21 and/or client 22 to a desired URL to be accessed on web server 40. Server 30 may also include any number of individual listeners (not explicitly shown) that may be used to process file transfer protocol (FTP), email, JAVA Message Server (JMS) and other protocols, and/or perform a variety of functions such as load balancing, using a number of various methods, as desired and according to the implementation.

Alternatively, one or more applications 31 and/or 32 may reside on a server 30 that may be another type of specific purpose or a general-purpose programmable computer, such as the ubiquitous personal computer (PC), which is well known in the art and readily commercially available. Server 30 may also include a portion of a computer adapted to execute any one of the well-known MS-DOS, PC DOS, OS2, UNIX, MAC OS, and WINDOWS operating systems, or other operating systems including unconventional operating systems. Server 30 may be coupled to remote clients 21 and/or 22 and/or web server 40 by any type of communication link.

Server 30 operates in conjunction with applications 31 and/or 32 to automatically forward a request requested by client 21 and/or client 22 to a desired URL to be accessed on web server 40. For example, in the embodiment shown in FIG. 1, server 30 may access and/or include programs or software routines of applications 31 and/or 32, depending on the particular application. Many methods for implementing a software architecture may be used and include, but are not limited to, the classes discussed below. Server 30 may be connected to, or include, a memory system, such as a cache or random access memory (not explicitly shown), suitable for storing all or a portion of these programs or routines and/or temporarily storing data during various processes performed by server 30. Memory may be used, among other things, to support real-time analysis and/or processing of data.

Remote clients 21 and/or 22 may be any network elements that are enabled to communicate using an Internet communications protocol, such as, for example, HTTP or WAP, and that may be uniquely identified via the protocol that each uses. That is, remote clients 21 and/or 22 may be browsers such as Internet Explorer that resides on any general or specific purpose computer, wireless device or other Internet appliance. Remote clients 21 and/or 22 are each operable to submit requests and receive responses using that protocol. For example, a WAP device may submit a request using WAP for a web page. This request may be translated to a desired URL using HTTP syntax by a WAP server or other network element with equivalent functionality. HTTP requests and responses follow a specific syntax known to those in the art. As one example, a simple URL request from a browser for a web page from a web server may have the form:

http://acmeserver/storefront/products/scripts/servletengine.class/homejsp.

Although the invention contemplates numerous methods for implementing the method as is discussed below, an example may be illustrative before discussing the steps referred to in FIG. 2. In a particular embodiment, server 30 may utilize a software architecture that includes applications 31 and/or 32, and that may be logically composed of several classes and interfaces. These classes may operate in a distributed environment and communicate with each other using distributed communications methods, and may include a distributed component architecture such as Common Object Request Broker Architecture (CORBA), JAVA Remote Method Invocation (RMI), and ENTERPRISE JAVABEANS.

As another example, a method for automatically forwarding a request requested by client 21 and/or client 22 to a desired URL to be accessed on web server 40 may in a particular embodiment utilize Universal Session Manager (USM) technology available from Hewlett-Packard. USM technology may, for example, utilize several classes in implementing an exemplary method as discussed below, using the HTTP protocol. An HttpSessionProxy class may be used as a receiver or listener in the ULF on a particular port for HTTP requests incoming from clients 21 and 22. The HttpSessionProxy class detects whether a mask is present in the request, and may then pass these requests to a desired URL through to web server 40 for further processing. In a particular embodiment, these requests may be processed through HttpSessionRequestExecutor and HttpProtocolHandler classes. For example, the HttpSessionRequestExecutor class may be used to communicate with an HttpProtocolHandler class to send HTTP requests to web server 40 and to parse HTTP requests and/or responses. Responses may similarly be passed from web server 40 to clients 21 and/or 22 through the HttpSessionRequestExecutor and HttpProtocolHandler classes. A SocketBinaryOutputObject class may also be used to pass data to client 21 and/or 22. For example, this class may be used to decode data utilizing a configured decoding algorithm, and to output headers and data to a Socket, which may then be passed via a context specified by the particular implementation.

An example of a mask and URL may be illustrative. FIG. 2 graphically illustrates a representation of an example of a mask that may be utilized according to an embodiment of the present invention. FIG. 2 illustrates an example of a desired URL 200, which includes a first portion 201, a second portion 202, and a substitutable portion 205 for which a mask 210 may be substituted in accordance with the teachings of the present invention. One of clients 21 and 22 may submit a request that includes first portion 201, second portion 202, and mask 210, which is then forwarded to the desired URL 200 using a method such as the one discussed in FIG. 3.

Mask 210 may be provided statically or dynamically, and may be any portion of a URL. For example, load balancing techniques may be used to allow clients 21 and/or 22 to utilize masks where traffic to particular web servers 40, or pages therein, is heavy. In a particular embodiment, an entire server may be assigned a mask that is implied. As one example, an implied mask 210 may be used with a web server 40 that is dedicated to a single application or URL. In this example, the mask 210 is represented by the string “acmeproducts”. That is, and according to a method such as the one discussed below in conjunction with FIG. 3, clients 21 and/or 22 need only include first portion 201, second portion 202, and mask 210 as a request for the request to be properly processed at the desired URL 200.

Moreover, where a web server 40 may in some embodiments be dedicated to a single application or URL, the need for client 21 to utilize mask 210 may be eliminated as discussed below. That is, application 31 and/or 32 may redirect all requests to a desired URL 200 for a web server 40 that is dedicated to a single application or URL, when client 21 or 22 requests a URL using an implied mask. That is, the request may in such an embodiment consist of only first portion 201 and second portion 202, and mask 210 is implied in addition to substitutable portion 205.

URL 200 is discussed merely as an example using two desired portions, first portion 201 and second portion 202. As illustrated in FIG. 2, first portion 201 precedes substitutable portion 205 or mask 210, and second portion 202 follows substitutable portion 205 or mask 210. The invention contemplates a desired URL that has fewer or more desired portions and/or one or more masks 210, depending on the application.

FIG. 3 illustrates an example of a method for automatically forwarding a request according to an embodiment of the present invention. Various embodiments may utilize fewer or more steps, and method 300 may be performed using a number of different implementations, depending on the application. Generally, the method provides for automatically forwarding a request from a client 20 or 21 to a web server 40. The method may provide the advantage of allowing clients 21 and 22 to access their requested URLs using ‘shorthand’ or ‘alias’ values, which trigger web server 40 to automatically direct the request to the client's desired URL.

In step 302, a request for a URL 200 is received from a client 21. The request includes at least a first portion 201 or second portion 202, depending on the request.

In step 304, the method detects whether at least a portion of the URL 200 is associated with a desired URL address, which is an unmasked URL address that is different from the request. If so, the desired URL will transform the request by further processing a mask 210. For example, the desired URL address includes, in addition to the first or second portion, at least another portion such as mask 210 or substitutable portion 205. In a particular embodiment, the request may include an implied mask 210. The method may make such a determination by a variety of methods including, but not limited to, parsing the request and comparing the parsed string with stored or queried data that may reside, for example, in a database (not explicitly shown). If the requested URL is the desired URL as received from client 21, the method automatically forwards the requested URL 200 to the desired URL in step 306.

If the request is associated with a desired URL address, in step 308, the method may optionally query whether the mask includes an implied mask in step 310. That is, and for example, where a web server 40 may in some embodiments be dedicated to a single application or URL, the method may redirect all requests to a desired URL 200 for a web server 40 that is dedicated to a single application or URL. The request may in such an embodiment consist of only first portion 201 and second portion 202. Thus, if the method detects an implied mask in step 310, the method may transform the request by adding mask 210 to the request. The method proceeds to transform the request in step 312. For example, where the request includes first portion 201, second portion 202, and mask 210, the method replaces mask 210 with substitutable portion 205 in the request. The method then proceeds to forward the request to the desired URL in step 306, which includes first and second portions 201 and 202 and substitutable portion 205 instead of mask 210.

What is claimed is:

1. A method for automatically forwarding a request, comprising:
receiving a request from an a client enabled to communicate using an Internet communications protocol, the request comprising at least a first portion;
transforming the request if the request is associated with a desired URL address that comprises the at least a first portion and another portion; and
automatically forwarding the request to the desired URL address.

2. The method of claim 1, wherein
the request comprises a mask; and
transforming the request comprises replacing the mask with a substitutable portion in the request.

3. The method of claim 1, wherein
the request comprises an implied mask; and
transforming the request comprises inserting the implied mask into the request.

4. The method of claim 1, wherein the client is a browser.

5. The method of claim 1, wherein the request specifies an HTML-enabled web page.

6. The method of claim 1, further comprising determining whether a mask exists for the URL address by searching a database.

7. The method of claim 1, wherein the Internet communications protocol comprises HTTP.

8. A system for automatically forwarding a request, comprising:
a server in a network, the server operable to receive a request over the network from a client enabled to communicate using an Internet communications protocol, the request comprising at least a first portion;
an automatic forwarding application resident on the server and operable to transform the request if the request is associated with a desired URL address that comprises the at least a first portion and another portion; and
automatically forward the request to the desired URL address.

9. The system of claim 8, wherein:
the request comprises a mask; and
the application is further operable to transform the request by replacing the mask with a substitutable portion in the request.

10. The system of claim 8, wherein the client is a wireless device.

11. The system of claim 8, wherein the application comprises one of a plurality of receivers in the server, the receivers each operable to receive and transfer requests using a unique protocol.

12. The system of claim 8, wherein the application comprises at least one class implemented by employing the language distributed under the name JAVA.

13. The system of claim 8, wherein:
the request comprises an implied mask; and
the application is further operable to transform the request by inserting the implied mask into the request.

14. The system of claim 8, the request specifies an HTML-enabled web page.

15. The system of claim 8, wherein the Internet communications protocol comprises HTTP.

16. An automatic request forwarding application, comprising:
a computer-readable storage medium;
application software resident on the computer-readable storage medium and operable to
receive a request from a client enabled to communicate using an Internet communications protocol, the request comprising at least a first portion;
transform the request if the request is associated with a desired URL address that comprises the at least a first portion and another portion; and
automatically forward the request to the desired URL address.

17. The application of claim 16, wherein the application software comprises one of a plurality of receivers in the server, the receivers each operable to receive and transfer requests using a unique protocol.

18. The application of claim 16, wherein the application software comprises at least one class implemented by employing the language distributed under the name JAVA.

19. The application of claim 16, wherein the client is a wireless device.

20. The application of claim 16, wherein:
the request comprises a mask; and
the application is further operable to transform the request by replacing the mask with a substitutable portion in the request.

21. The application of claim 16, wherein:
the request comprises an implied mask; and
the application is further operable to transform the request by inserting the implied mask into the request.

22. The application of claim 16, wherein the request specifies an HTML-enabled web page.

23. The application of claim 16, wherein the Internet communications protocol comprises HTTP.
